(19) United States
(12) Patent Application Publication
(10) Pub. No.: US 2013/0019755 A1
(43) Pub. Date: Jan. 24, 2013

(54) BREWING DEVICE

(71) Applicants: PAO-WU TIEN, Taipei City (TW); Yu-Mei Tien Lin, Taipei City (TW)

(72) Inventors: PAO-WU TIEN, Taipei City (TW); Yu-Mei Tien Lin, Taipei City (TW)

(21) Appl. No.: 13/188,471

(22) Filed: Jul. 22, 2011

(51) Int. Cl. A47J 31/44

(52) U.S. Cl. 99/279

(57) ABSTRACT

The brewing device contains a container and a functional unit beneath the container conductive to the container. The functional unit contains a pressure section and an exit section. The pressure section is conductive to and is smaller than the container. The pressure section is configured with air holes for drawing outside air. The exit section is conductive to and is smaller than the exit section. As the brewed liquid (such as the coffee brewed from the coffee powder) flows through the pressure section, it undergoes a pre-determined pressure through the air holes. Additionally, the container and the functional unit jointly achieve Venturi effect so that the brewed liquid is sped up under greater pressure difference as it passes through the exit section. As such, the molecules of the brewed liquid are activated and thinned to achieve enhanced flavor.

### (a) TECHNICAL FIELD OF THE INVENTION

The present invention is generally related to coffee or tea brewing devices, and more particularly to a brewing device where a predetermined air pressure is exerted on the brewed liquid before its dripping out so that the liquid molecules are activated and thinned.

### (b) DESCRIPTION OF THE PRIOR ART

Coffee or tea has become the most popular drinks among people. They are commonly offered during gatherings of friends and relatives as making or brewing coffee or tea is economic, fast, and convenient. However, most conventional brewing devices are complex-structured and operated inconveniently.

Existing brewing devices mainly contain a cup member with a dripping hole at the bottom. Then, a filtering paper with coffee ground is placed in the cup member and hot water is poured into the cup member. Subsequently, coffee by the hot water and the coffee powder is filtered and flows out of the dripping hole directly. As the coffee powder is usually only partially utilized, and as no pressure is exerted, the coffee molecules are not activated and thinned, there is little enhancement to the flavor of the coffee and the brewing device only provides filtering function.

### SUMMARY OF THE INVENTION

Therefore, a novel brewing device is provided herein capable of activating brewed liquid molecules.

The brewing device contains a container and a functional unit beneath the container conductive to the container. The functional unit contains a pressure section and an exit section. The pressure section is conductive to and is smaller than the container. The pressure section is configured with air holes for drawing outside air. The exit section is conductive to and is smaller than the exit section. As the brewed liquid (such as the coffee brewed from the coffee powder) flows through the pressure section, it undergoes a pre-determined pressure through the air holes. Additionally, the container and the functional unit jointly achieve Venturi effect so that the brewed liquid is sped up under greater pressure difference as it passes through the exit section. As such, the molecules of the brewed liquid are activated and thinned to achieve enhanced flavor.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective diagram showing a brewing device according to an embodiment of the present invention.

FIG. 2 is a perspective diagram showing the interior of the brewing device of FIG. 1.

FIG. 3 is a sectional diagram showing the brewing device of FIG. 1.

FIG. 4 is a sectional diagram showing an operation scenario of the brewing device of FIG. 1.

FIG. 5 is a perspective diagram showing the brewing device of FIG. 1 to be joined to a supporting stand.

FIG. 6 is a sectional diagram showing an operation scenario of the brewing device of FIG. 5 with filtering paper ins ailed.

FIG. 7 is a sectional diagram showing an operation scenario of the brewing device of FIG. 5 with filtering mesh installed.

FIG. 8 is a sectional diagram showing an operation scenario of the brewing device of FIG. 5 with valves configured at the air holes.

FIG. 9 is a perspective diagram showing the brewing device of FIG. 1 to be joined to a supporting stand of another embodiment.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

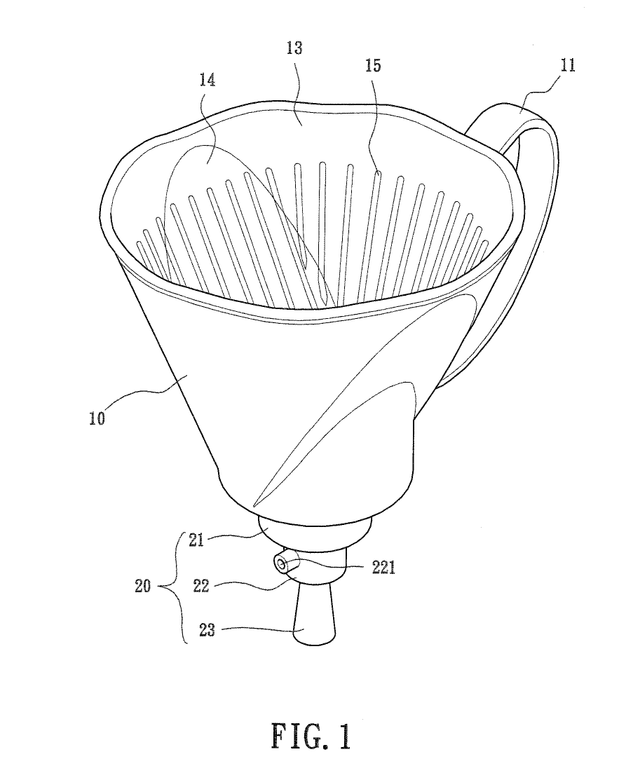

As shown in FIG. 1, a brewing device according to an embodiment of the present invention contains a container 10 and a functional unit 20 beneath the container 10. The functional unit 20 is smaller than the container 10 and exerts a pre-determined pressure to the brewed liquid. The brewed liquid therefore drips at a higher speed and has an enhanced flavor due to the activating and thinning of the liquid molecules.

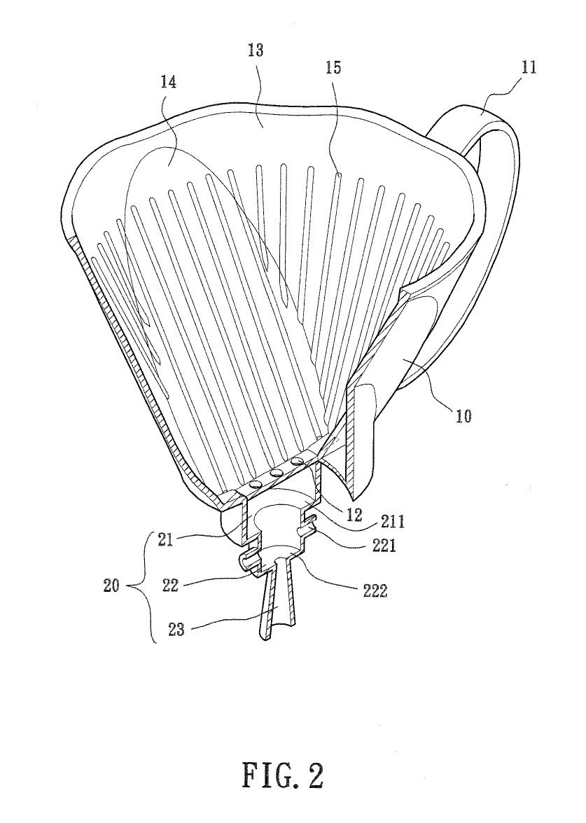

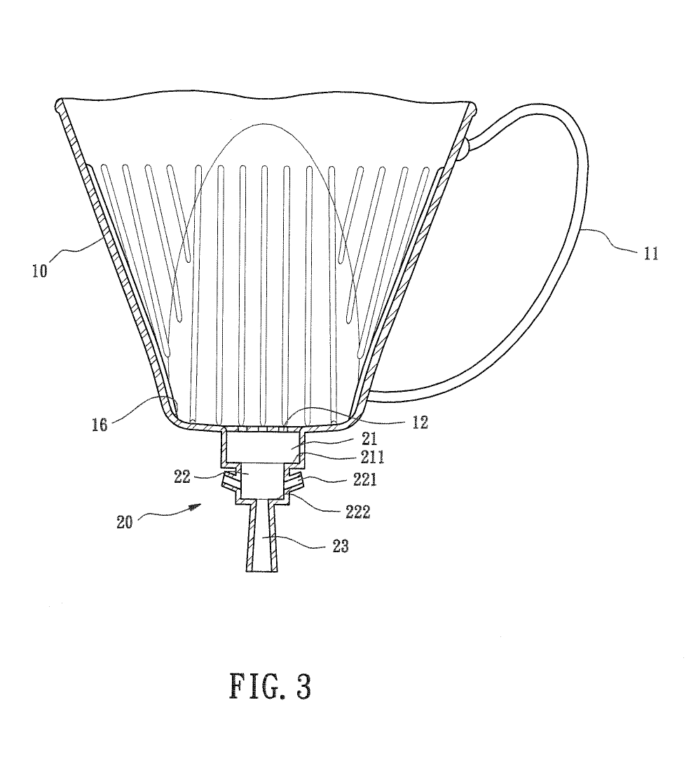

As shown in FIGS. 2 and 3, the container 10 has a handle 11 at a side to facilitate manual holding. There are a number of dripping holes 12 at the bottom of the container 10 for brewed liquid to flow through. Inside the container 10, an up-side-down conic shape is formed with curved surface 13 and two opposing slant surfaces 14 extended upward slantwise from the dripping holes 12. There are also a number of ribs 15 inside the container 10 extended from the dripping holes 12. Arc angles 16 are formed between the bottom and inner wall of the container 10 for guiding liquid and facilitating cleaning.

The functional unit 20 is located beneath the container 10 which contains an entry section 21, a pressure section 22, and an exit section 23. The entry section 21 is smaller than the container 10 and conductive to the container 10 through the dripping holes 12. The pressure section 22's aperture is smaller than or equal to that of the entry section 2, and the pressure section 22 has air holes 221 allowing air to flow in. In the present embodiment, the air holes 221 are embodied by slant tubes whereas, in alternative embodiments, the air holes 221 could also be embodied by level tubes. In addition, the pressure section 22 is smaller than the entry section 21 in the present embodiment so that corners 211 are formed therebetween. The exit section 23 is conductive to the pressure section 22 and is extended downward with a gradually enlarged aperture, thereby having a horn-like shape and an ejection effect to the brewed liquid. The exit section 23 has a smaller or equal aperture to that of the pressure section 22. In the present embodiment, the exit section 23 is smaller than the pressure section 22 and corners 222 are formed therebetween.

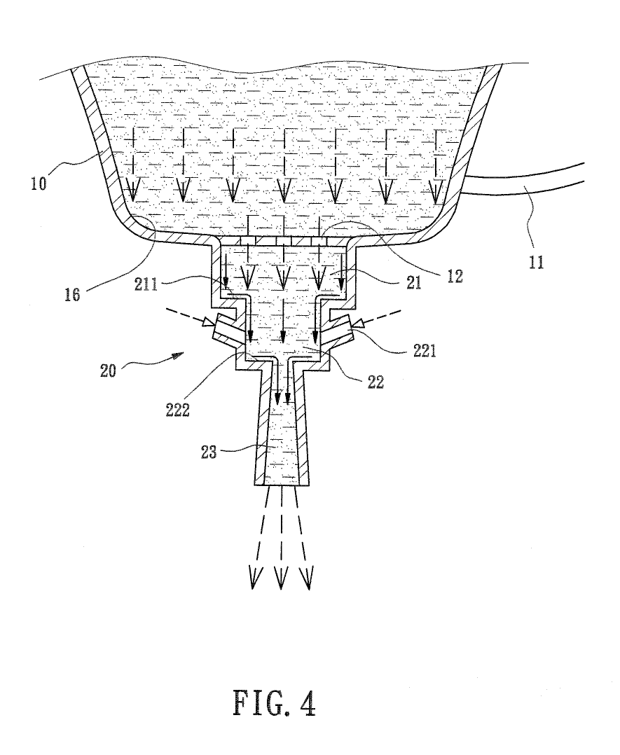

As shown in FIG. 4, a user could hold the container 10 by the handle 11 and store brewed liquid (such as coffee brewed from coffee powder) into the container 10. The brewed liquid then flow through the dripping holes 12 into the entry section 21, and then from the entry section 21 into the pressure section 22. Outside air enters the pressure section 22 through the air holes 221 to exert a pre-determined pressure on the brewed liquid. As the apertures of the entry and pressure sections 21 and 22 are smaller than that of the container 10, the Venturi effect is achieved and the brewed liquid undergoes pressure difference and speedup as it flows through the entry and pressure sections 21 and 22 and ejects out of the exit section 23 in foam. As such, the molecules of the brewed liquid are activated and thinned, achieving a superior flavor.

As shown in FIG. 4, as the brewed liquid flows downward, it splashes head-on against the corners 211 and 222. Additionally, the corners 211 and 222 cause the turbulence in the brewed liquid and, as such, outside air is drawn into the pressure section 22 through the air holes 221 to create the pre-determined pressure to the brewed liquid. Therefore, as the brewed liquid passes through the entry and pressure sections 21 and 22, a greater pressure difference as well as a higher speed is achieved according to the flow dynamics. When the brewed liquid runs through the exit section 23, due to its horn-like shape, foam is ejected, thereby activating and thinning the molecules of the brewed liquid.

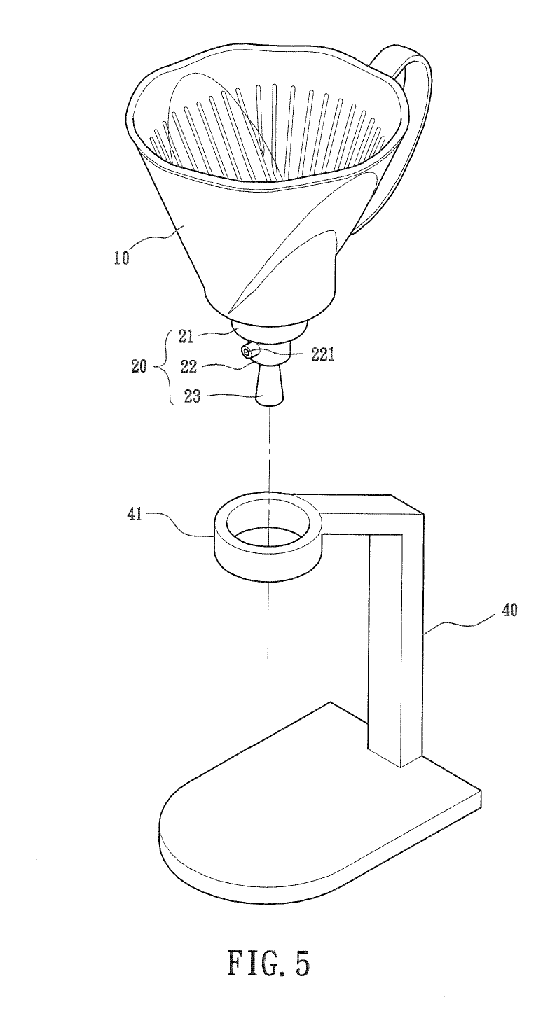

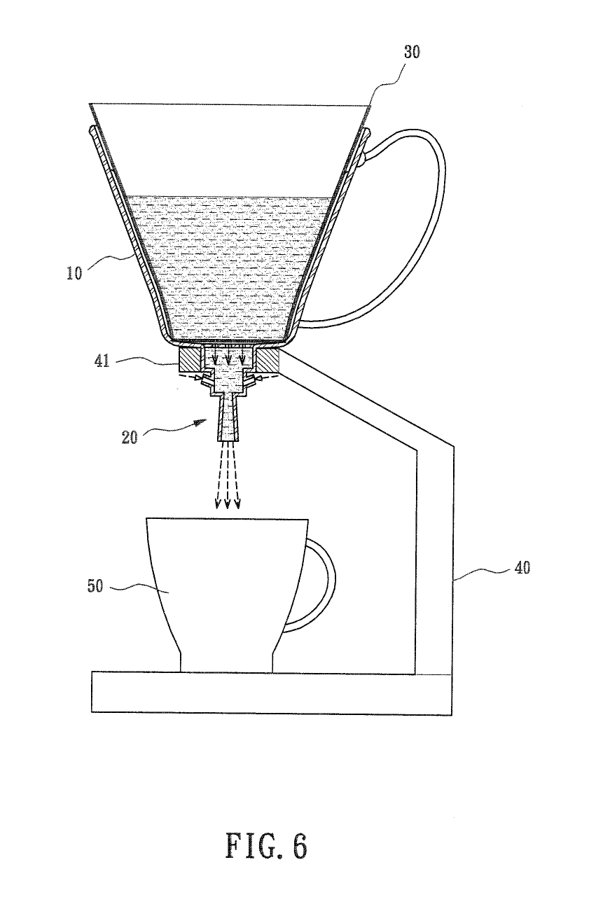

As shown in FIGS. 5 and 6, a filtering paper 30 with coffee powder is placed in the container 10 and hot water is poured into the container 10 to produce the brewed coffee. As the brewed coffee is filtered by the filtering paper 30, the curved surface 13, the slant surfaces 14, and the ribs 15 help guiding the brewed coffee to flow into the functional unit 20 smoothly, where it is activated and ejected.

Additionally, the brewing device of the present invention could be used along with a supporting stand 40 which has a positioning ring 41 through which the functional unit 20 is threaded and on which the bottom of the container 10 is rested. As such, the brewing device could be held at a specific height automatically. Beneath the functional unit 20, a cup 50 could be placed to receive the activated, ejected brewed coffee.

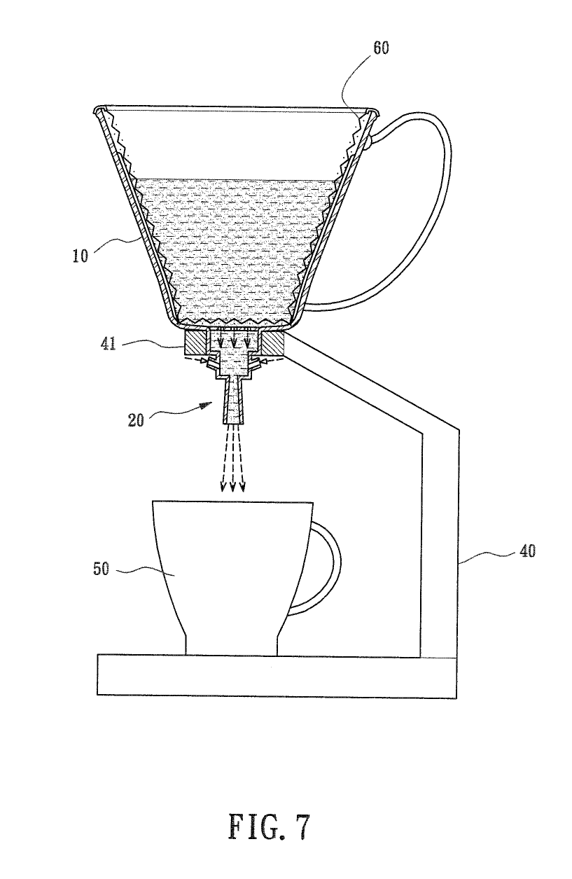

As shown in FIG. 7, alternatively, a filtering mesh 60 with coffee powder could be placed inside the container 10 to produce brewed coffee.

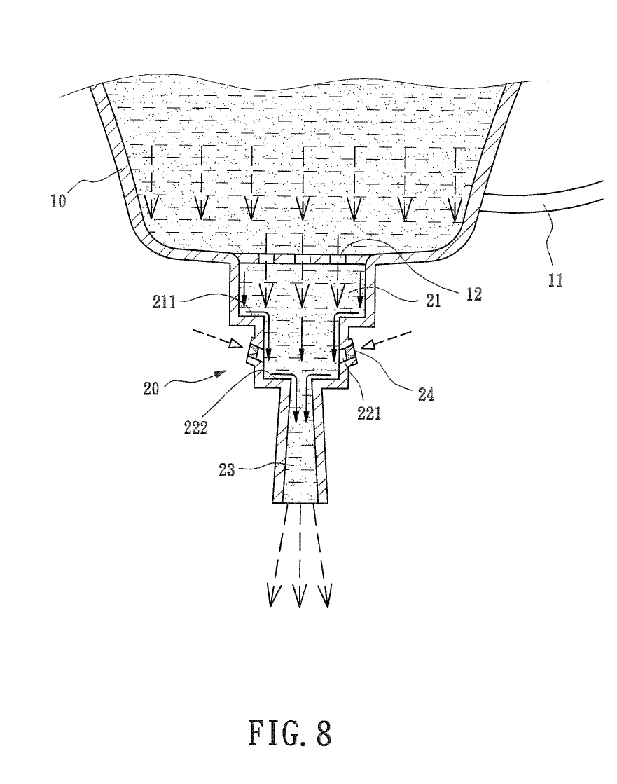

As shown in FIG. 8, an optional one-way valve 24 could be configured inside the air holes 221 so that outside air could only enter the pressure section 22 and the brewed liquid could not overflow through the air holes 22.

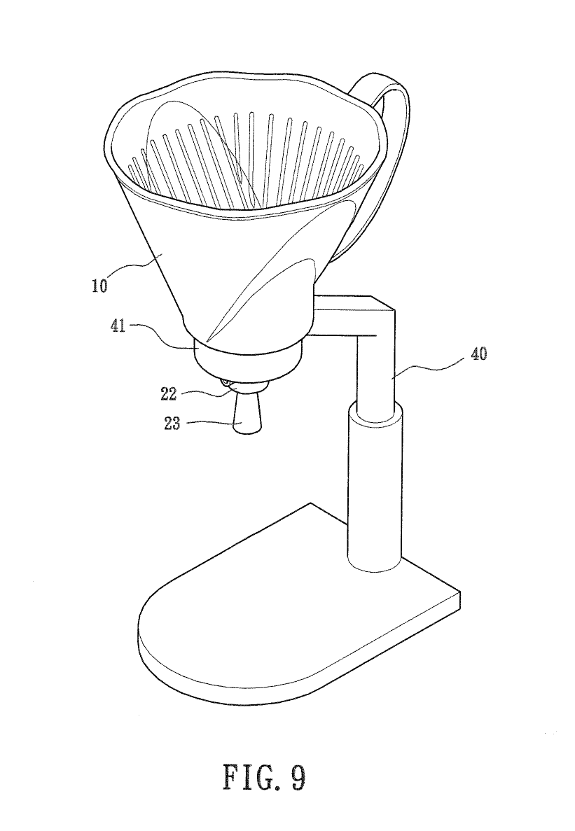

As shown in FIG. 9, the supporting stand 40 could have a telescoping structure so that the brewing device could be held at various heights as required.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A brewing device, comprising:
a container; and
a functional unit beneath and conductive to said container, said functional unit having a pressure section and an exit section, said pressure section conductive to and smaller than said container, said pressure section configured with at least an air hole for drawing outside air, said exit section beneath and conductive to said pressure section;
wherein, as a brewed liquid in said container flows through said pressure section, said brewed liquid undergoes a pre-determined pressure through said air holes; said container and functional unit jointly achieve Venturi effect so that said brewed liquid is sped up under greater pressure difference as said brewed liquid passes through said exit section; and, as such, the molecules of said brewed liquid are activated and thinned before said brewed liquid flows out of said exit section.

2. The brewing device according to claim 1, wherein a handle is configured to a side of said container.

3. The brewing device according to claim 1, wherein said functional unit is conductive to said container through a plurality of dripping holes configured at the bottom of said container.

4. The brewing device according to claim 1, wherein an up-side-down conic shape is formed inside said container with curved surface and two opposing slant surfaces extended upward slantwise from the bottom of said container.

5. The brewing device according to claim 1, wherein a plurality of ribs are configured inside said container.

6. The brewing device according to claim 1, wherein said functional unit further comprises an entry section between said container and said pressure section; and said entry section is smaller than said container.

7. The brewing device according to claim 6, wherein a corner is formed between said pressure and entry sections.

8. The brewing device according to claim 1, wherein each of said air holes is a slant tube.

9. The brewing device according to claim 1, wherein said exit section has a horn shape with gradually increasing aperture as said exit section extends downward.

10. The brewing device according to claim 1, wherein said exit section is smaller than or equal to said pressure section.

11. The brewing device according to claim 1, wherein a corner is formed between said pressure and exit sections.

12. The brewing device according to claim 1, wherein a one-way valve is configured inside each of said air holes.

13. The brewing device according to claim 1, wherein a filtering paper is provided inside said container.

14. The brewing device according to claim 1, wherein a filtering mesh is provided inside said container.

15. The brewing device according to claim 1, further comprising a supporting stand having a positioning ring through which said functional unit is threaded and on which the bottom of said container is rested; wherein said supporting stand has a telescoping structure so that the height of said positioning ring is adjustable.
